(19) United States
(12) Patent Application Publication
(10) Pub. No.: US 2020/0393544 A1
(43) Pub. Date: Dec. 17, 2020

(54) Illuminated Aperture Emitter For Three-Dimensional Position Measurement

(71) Applicant: Perceptron, Inc., Plymouth, MI (US)

(72) Inventors: Bodo EHLERS, Northville, MI (US); James WEST, South Lyon, MI (US); Jason WILSON, Plymouth, MI (US)

(21) Appl. No.: 16/440,374

(22) Filed: Jun. 13, 2019

(51) Int. Cl. G01S 7/481; G02B 5/00; G01S 17/06

(52) U.S. Cl. CPC G01S 7/4815; G01S 17/06; G02B 5/005

(57) ABSTRACT

A system for measuring a position of a rigid object is provided. The system includes one or more light emitters disposed on one or more surfaces of the rigid object and an optical measurement instrument. Each light emitter includes a light-emitting device having a light-emitting surface, a transparent plate disposed on the light-emitting surface, and an opaque film disposed between the light-emitting surface and the transparent plate. The opaque film includes an aperture that is aligned with the light-emitting surface. The optical measurement instrument is configured to receive light from one or more light emitters and to use the received light to determine the position of the rigid object using the received light.

### FIELD

The present disclosure relates to an illuminated aperture emitter for three-dimensional position measurement.

### BACKGROUND

Constellations of light emitters are often used by automated and manual optical measurement instruments to measure movement of a rigid body in three-dimensional space—i.e., the six degrees of freedom (“6DoF”). Constellations include signal data for a variety of single-point light emitters that are stably mounted on a rigid body and subsequently viewed by an optical receiving element that collects the emitted light onto imaging sensors. Once collected, the signal data is processed by a computing element to derive the six degree of freedom position of the rigid body in free space.

In such instances, to provide spatial accuracy the three-dimensional position of each emitter must be known relative to each other, as well as with regard to the rigid body onto which the emitters are mounted. The three-dimensional positions of the light emitters are generally measured during manufacturing of measurement instrument using a calibration process. For example, in various instances, such calibration processes may utilize various optical means to measure the spatial position of the emitters, and in various other instances, various mechanical means—such as a ruby-tipped probe deployed on a Coordinate Measuring Machine (“CMM”)—may be used. The various mechanical means provide greater accuracy than the various optical means; however, because of the small and delicate nature of the emitters, it is often difficult to mechanically measure the three-dimensional position of the light emitters.

Various other factors may also affect the precise accuracy of such calibration processes and/or measurement instrument. For example, in certain instances, the emitters include bare light emitting diode (“LED”) dies and anode wires. In such instances, when portions of the light emitters are environmentally exposed, airborne debris commonly found in manufacturing plants may fall onto the dies and/or wires so as to skew the calibration method and/or permanently or temporarily render the measurement instrument non-functional. In the instance of coherent fiber bundles, discrepancies in centering the LED under the fiber bundle are common.

Accordingly, it would be desirable to develop devices and methods that improve the ruggedness and accuracy of three-dimensional position measurements.

This section provides background information related to the present disclosure which is not necessarily prior art.

### SUMMARY

This section provides a general summary of the disclosure, and is not a comprehensive disclosure of its full scope or all of its features.

In various aspects, the present disclosure provides a system for measuring a position of a rigid object. The system includes one or more light emitters disposed on one or more surfaces of the rigid object and an optical measurement instrument configured to receive light from the one or more light emitters and further configured to determine the position of the rigid object using the received light. Each light emitter includes a light-emitting device having a light-emitting surface, a transparent plate disposed on the light-emitting surface, and an opaque film disposed between the light-emitting surface and the transparent plate. The opaque film includes an aperture that is aligned with the light-emitting surface.

In one aspect, the transparent plate may define an edge of the light emitter and one or more positions along the edge of the light emitter may be measured using a mechanical coordinate-measuring machine (“CMM”).

In one aspect, the optical measurement instrument may be further configured to receive the one or more edge measurements and to use the one or more edge measurements to determine the position of the rigid object.

In one aspect, the aperture may have a first longest dimension that is smaller than a second longest dimension of the light-emitting surface, such that edges of the light-emitting surface are not visible through the aperture over a large angle.

In one aspect, the aperture may have one of a circular shape, an elliptical shape, and a shape of an even-sided polygon. The light-emitting surface may have one of a circular shape, an elliptical shape, and a shape of an even-sided polygon.

In one aspect, a first longest dimension of the aperture may be greater than 100:1 by ratio of a thickness of the opaque film, and a first thickness of the transparent plate may be greater than a second thickness of the opaque film.

In one aspect, the transparent plate may be a glass plate comprising fused silica, sapphire, soda lime glass, boro-silicate, or a combination thereof. The opaque film may be a film comprising chrome, silver, aluminum, carbon, dielectric, or a combination thereof.

In one aspect, the opaque film may cover less than an entire surface area of a first surface of the transparent plate, and exposed areas of the first surface of the transparent plate may be bonded to the rigid object.

In one aspect, the exposed areas of the first surface of the transparent plate may be bonded to the rigid object using ultraviolet curing.

In one aspect, the opaque film may be disposed on a first surface of the transparent plate using a vapor deposition process and the aperture may be formed in the opaque film using an etching process. The transparent plate may be fabricated using a semiconductor fabrication technique selected from laser dicing and saw dicing.

In various other aspects, the present disclosure provides a system of measuring a position of a rigid object. The system includes one or more light emitters disposed on one or more surfaces of the rigid object and an optical measurement. Each light includes a light-emitting device having a light-emitting surface, and a transparent plate disposed on the light-emitting surface. An opaque film having an aperture defined therein coats a first surface of the transparent plate, and the transparent plate defines an edge of the light emitter. The optical measurement instrument is configured to receive light from the one or more light emitters and one or more edge measurements for each light emitter. The optical measurement instrument is further configured to determine the position of the rigid object using the received light and the one or more edge measurements.

In one aspect, the one or more edge measurements may be measured using a mechanical coordinate-measuring machine (“CMM”).

In one aspect, the aperture may be registered to the edge of the light emitter and may have a first longest dimension that is smaller than a second longest dimension of the light-emitting surface, such that edges of the light-emitting surface are not visible through the aperture over a large angle. The first longest dimension of the aperture may be greater than 100:1 by ratio of a thickness of the opaque film, and a first thickness of the transparent plate may be greater than a second thickness of the opaque film.

In one aspect, the transparent plate may be a glass plate comprising fused silica, sapphire, soda lime glass, boro-silicate, or a combination thereof. The opaque film may be a film comprising chrome, silver, aluminum, carbon, dielectric, or a combination thereof.

In one aspect, the opaque film may cover less than an entire surface area of the first surface of the transparent plate, and exposed areas of the first surface of the transparent plate may be bonded to the rigid object.

In yet another aspect, the present disclosure provides a method for measuring a position of a rigid object. The rigid object may include one or more light emitters disposed on one or more surfaces thereof. The method includes measuring one or more positions along an edge of each light emitter. Each light emitter includes a light-emitting device having a light-emitting surface, and a transparent plate disposed on the light-emitting surface. The transparent plate defines the edge of the light emitter, and an opaque film having an aperture defined therein coats a first surface of the transparent plate. The method further includes using the edge measurements to determine a three-dimensional position for each aperture and receiving light from the one or more light emitters. The light received from the one or more light emitters and the three-dimensional position of each aperture are used to determine the position of the rigid object.

In one aspect, the one or more positions along the edge of the light emitter may be measured using a mechanical coordinate-measuring machine.

In one aspect, the opaque film may be disposed on the first surface of the transparent plate using a vapor deposition process and the aperture may be formed in the opaque film using an etching process. The transparent plate may be fabricated using a semiconductor fabrication technique selected from laser dicing and saw dicing.

In one aspect, the aperture may have a first longest dimension that is smaller than a second longest dimension of the light-emitting surface, such that edges of the light-emitting surface are not visible through the aperture over a large angle. The first longest dimension of the aperture may be greater than 100:1 by ratio of a thickness of the opaque film and a first thickness of the transparent plate is greater than a second thickness of the opaque film.

In one aspect, the transparent plate may be a glass plate comprising fused silica, sapphire, soda lime glass, boro-silicate, or a combination there. The opaque film may be a film comprising chrome, silver, aluminum, carbon, dielectric, or a combination thereof. The opaque film may cover less than an entire surface area of the first surface of the transparent plate, and exposed areas of the first surface of the transparent plate may be bonded to the rigid object.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A is an exploded view of an example light emitter in accordance with various aspects of the present disclosure;

FIG. 1B is a constructed view of the example light emitter illustrated in FIG. 1A;

FIG. 2 is a flowchart illustrating an example method for making a light emitter in accordance with various aspects of the present disclosure;

FIG. 3A is an example rigid body having one or more light emitters disposed on one or more surfaces thereof in accordance with various aspects of the present disclosure;

FIG. 3B is a close-up view of a portion of the rigid body illustrated in FIG. 3A;

FIGS. 4A-4B illustrate approaches for mechanically measuring various points or position of the one or more light emitters disposed on the rigid body, as illustrated in FIGS. 3A-3B;

FIG. 5 is a block diagram showing the relationship between the rigid body, as illustrated in FIGS. 3A-3B; the mechanical coordinate-measuring machine, as illustrated in FIGS. 4A-4B; and an example receiving element that receives information from the light emitters disposed on the rigid body and the mechanical coordinate-measuring machine; and

FIG. 6 is a flowchart illustrating an example method of measuring a position of a rigid object to a known reference frame in accordance with various aspects of the present disclosure.

Corresponding reference numerals indicate corresponding parts throughout the several views of the drawings.

### DETAILED DESCRIPTION

Example embodiments will now be described more fully with reference to the accompanying drawings.

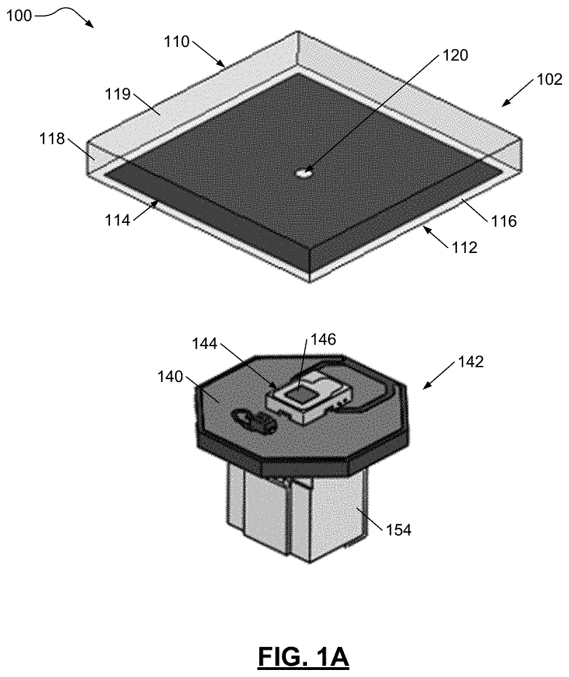

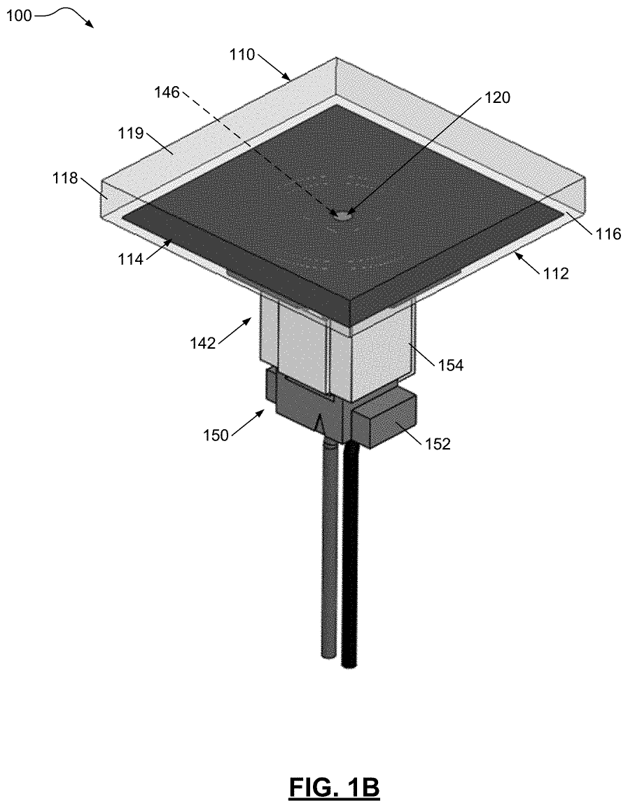

With reference to FIG. 1A, an exploded view of an example light emitter 100 is provided. The light emitter 100 comprises an opaque member 102 disposed on a light-emitting device 142. The opaque member 102 comprises a transparent plate 110 having a first surface 112 whereon an opaque film 114 is disposed. An aperture or pore 120 is formed in the opaque film 114. For example, the opaque film 114 may be disposed onto the transparent plate 110 and the aperture 120 may then be etched into the opaque film 114. For example, the opaque film 114 may be disposed onto the transparent plate 110 using a vapor deposition process. In various other embodiments, the aperture 120 may be formed in the opaque film 114 before the film 114 is disposed on the first surface 112 of the transparent plate 110. For example, the aperture 120 may be first punched, laser cut, or etched into the opaque film 114, and the modified film 114 may then be disposed on the transparent plate 110. For example, in certain instances, the modified opaque film 114 may be electroformed onto the transparent plate 110.

The aperture 120 may be formed at any point along the opaque film 114, so long as the aperture 120 is formed or disposed at a known location relative to the edges 118 of the transparent plate 110. For example, as seen in the illustrated embodiment, the aperture 120 may be formed at a center point of the film 114 and disposed centrally on the transparent plate 110. The aperture 120 may take a variety of shapes. For example, as seen in the illustrated embodiment, the aperture 120 may have a circular shape. In various other aspects, the aperture 120 may have an elliptical shape or the shape of an even-sided polygon, such as a square.

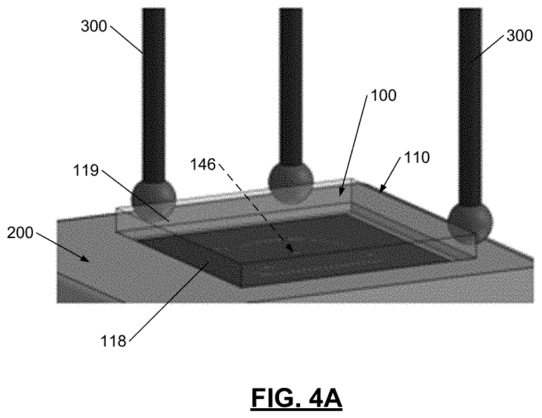

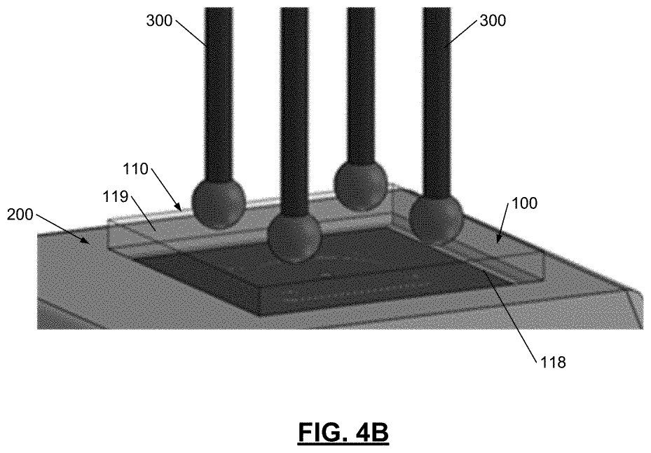

In various aspects, the transparent plate 110 may be any durable transparent material and the opaque film 114 may be any opaque material. For example, in various instances, the transparent plate 110 may be a glass plate comprising fused silica, sapphire, soda lime glass, boro-silicate, or combinations thereof; and the transparent film 114 may comprise one or more opaque materials, such as chrome, silver, aluminum, carbon, dielectric, or combinations thereof. In various embodiments, the transparent plate 110 may have a first thickness ranging from greater than or equal to about 1 mm to less than or equal to about 3 mm. As best illustrated in FIG. 4A, the thickness of the transparent plate 110 defines the edges 118 of the transparent plate 110 and a perimeter of the light emitter 100. The opaque film 114 may have a second thickness ranging from greater than or equal to about 20 nm to less than or equal to about 10 μm. For example, in certain instances, the second thickness may be about 5 nm. The ratio between the longest length or diameter of the aperture 120 and the thickness of the opaque film 114 is greater than about 100:1. For example, in certain instances, the aperture 120 may have a longest length or diameter of about 700 μm, while the opaque film 114 has a thickness of about 30 nm.

The plate 110 and film 114 are fabricated using any accurate fabrication method. As best illustrated in FIG. 4A, one or more positions along the edge 118 and/or exposed surface 119 of the transparent plate 110 are measured and the measurements are used to infer the position of the aperture 120 and light emitter 100. As such, accurate fabrication of both the transparent plate 110 and the opaque film 114 and subsequent placement of the film 114 on the first surface 112 of the plate 110 are especially important. In various instances, semiconductor fabrication techniques, such as laser dicing and/or saw dicing, are used to fabricate the transparent plate 110 and/or opaque film 114. In the instance of laser dicing, a laser beam is scanned along the intended cutting lines and induces micro-fractures in the transparent plate 110 causing the separation. The film 114 may be disposed on the plate 110 using any accurate patterning process, such as photolithography, silk screening, and/or electro-forming.

As illustrated in FIG. 1B, the opaque member 102 is disposed on a first surface 140 of a light-emitting device 142. In various instances, the opaque member 102 may be bonded to the light-emitting device 142 by clamping or gluing the opaque film 114 to the first surface 140 of the light-emitting device 142. The light-emitting device 142 includes a light-emitting diode 144 having a light-emitting surface 146. The opaque member 102 is disposed on the light-emitting device 142 so the aperture 120 is aligned with the light-emitting surface 146. For example, as seen illustrated, the opaque member 102 may be disposed so that the aperture 120 is centered on the light-emitting surface 146.

Like the aperture 120, the light-emitting surface 146 may take a variety of shapes. For example, as seen illustrated, the light-emitting surface 146 may have a square shape. In various other aspects, the light-emitting surface 146 may have a circular shape, an elliptical shape, or the shape of another even-sided polygon. The longest length or diameter of the aperture 120 (i.e., the first longest dimension) is smaller than the longest length or diameter of the light-emitting surface 146 (i.e., the second longest dimension). The smaller first diameter of the aperture 120 may optimize the intensity and uniformity of light emitted by the light-emitting diode 144—for example, such that edges of the light-emitting surface 146 are not visible through the aperture 120 over large angles (e.g., ±60 degrees).

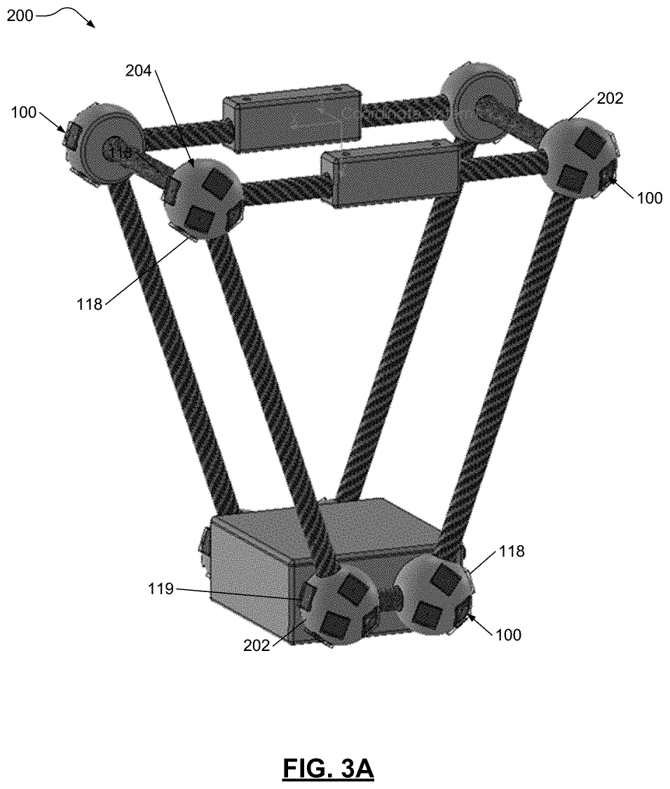

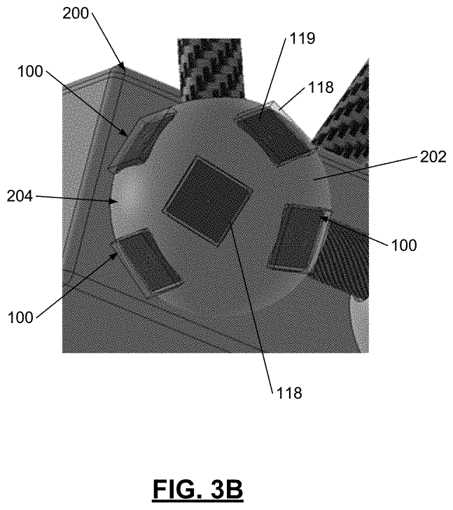

The light emitter 100 may be coupled to a power source 150 via a corresponding module plug 152 and jack 154. The jack or receiver 154 is coupled to the light-emitting device 142 and the plug 152 is coupled to the power source 150. In certain aspects, as illustrated in FIGS. 3A-3B, the power source 150 may be embedded within the rigid object 200. In such instances, the rigid object 200 may provide the plug 152 that couples to the receiver 154 of the light-emitting device 142.

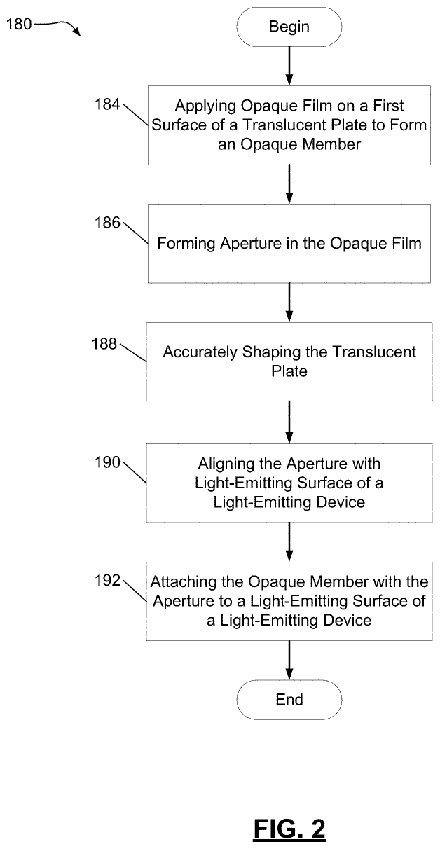

FIG. 2 is a flowchart illustrating an example method 180 for making or manufacturing a light emitter in accordance with various aspects of the present disclosure. The method includes, at 184, disposing on a first surface of a transparent plate an opaque film. In certain variations, the transparent plate may be a glass plate comprising silica and the opaque film may comprise chrome. In various instances, the opaque film may be disposed on the first surface of the transparent plate using a plating process, and in various other instances, one or more vapor deposition processes.

After the opaque film is disposed on the first surface of the transparent plate, an aperture is formed in the opaque film at 186 using, for example, etching or liftoff processes; and at 188, the method includes accurately cutting the transparent plate using, for example, a semiconductor fabricating technique. The opaque member including the transparent plate and the etched opaque film—i.e., the aperture—is disposed on a light-emitting device. In particular, at 190, the aperture formed in the opaque film is aligned with a light-emitting surface of the light-emitting device and, at 192, the opaque member is attached to the light-emitting device.

FIG. 3A illustrates a rigid body 200 having one or more light emitters 100 disposed on one or more surfaces 202 thereof; and FIG. 3B is a close-up view of a portion of the rigid body 200. As illustrated, the one or more light emitters 100 are disposed on the various surfaces 202 of the rigid body 200 such that the transparent plate 110 sits on top of the one or more receiving surfaces 202 of the rigid body 200. In various aspects, the rigid body 200 includes a plurality of semi-spheres 204 comprising aluminum and the one or more light emitters 100 may be disposed on the one or more of the plurality of semi-spheres 204. In certain instances, the rigid body 200 may include a plurality of cavities (not shown) that are configured to accept the one or more light emitters 100. For example, such cavities may be configured to accept the connector and/or cable attached to the light-emitting device 142. In all instances, as noted, the edges 118 of the plate 110 are exposed.

In various aspects, the one or more positions along the edge 118 and/or exposed surface 119 of the plate 110 may be measured and the measurements may be used to determine the three-dimensional position of each aperture 120. For example, in certain variations, two or more positions along the edge 118 of the plate 110, and in certain instances, optionally three or more positions along the edge 118 of the transparent plate 110, may be measured. Further, two or more positions along the exposed surface 119, and in certain instances, optionally three or more positions along the exposed surface 119 of the transparent plate 110, may be measured, such that six or more positions along the transparent plate 110 are measured. The six or more positions measured along the transparent plate 110 are used to determine the three-dimensional position of the aperture 120 of the particular light emitter 100.

In various aspects, optical means may be used to measure the one or more positions. In various other instances, one or more mechanical methods may be used to measure the one or more positions. For example, as illustrated in FIGS. 4A-4B, a mechanical coordinate-measuring machine (“CMM”) equipped with a ruby-tipped probe may be used to accurately measure the three-dimensional position of the transparent plate 110. For example, as seen in FIG. 4A, one or more probe positions 300 may measure one or more locations along the periphery edge 118 of the plate 110. In certain instances, as illustrated in FIG. 4B, the one or more probe positions 300 may also measure one or more locations on the exposed surface 119 of the transparent plate 110.

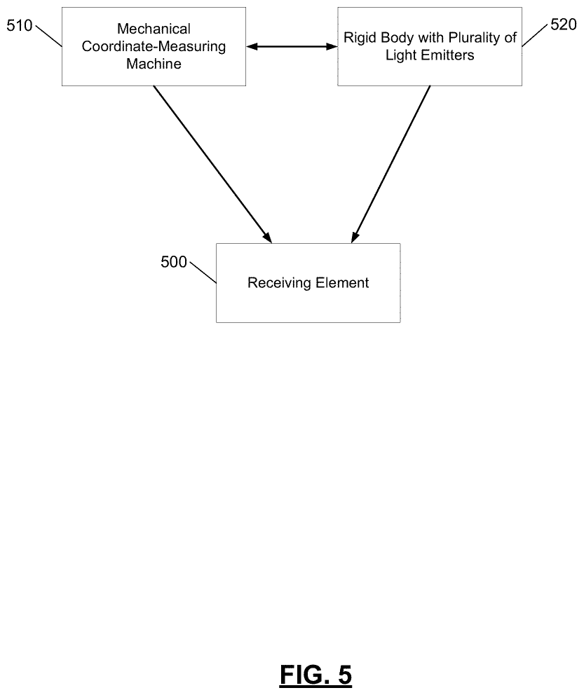

As noted, the measurements of the one or more positions along the edge 118 of the precisely defined transparent plate 110 and the measurements of the one or more exposed surface 119 of the precisely defined transparent plate 110 may be used to determine the three-dimensional position of the plate 110. For example, as illustrated in FIG. 5, the measurements of the one or more positions along the edge 118 of the plate 110 and the measurements of the one or more positions along the exposed surface 119 of the plate 110 may be received by a receiving element 500 and, using the measurements, the receiving element 500 may determine the three-dimensional position of the plate 110. In various instances, the receiving element 500 may receive the measurements from the mechanical coordinate-measuring machine 510.

The receiving element 500 may use the three-dimensional position of the transparent plate 110 to determine the three-dimensional position of the aperture 120. For example, the meticulous fabrication of the light emitter 100, including the positioning of the aperture 120 and subsequent alignment of the aperture 120 and light-emitting surface 146, may allow the position of the aperture 120 to be inferred using known variables once the edges 118 of the transparent plate 110 are defined. Using the inferred position of the aperture 120 and light emitted 520 by the light emitter 100 and received by the receiving device 500, the receiving device 500 may determine the position of the rigid object 200. For example, the one or more light emitters 100 are registered to a specific position on the rigid body 200. Therefore, as with the fabrication of each light emitter 100, the position of the rigid body 200 may be determined using known variables.

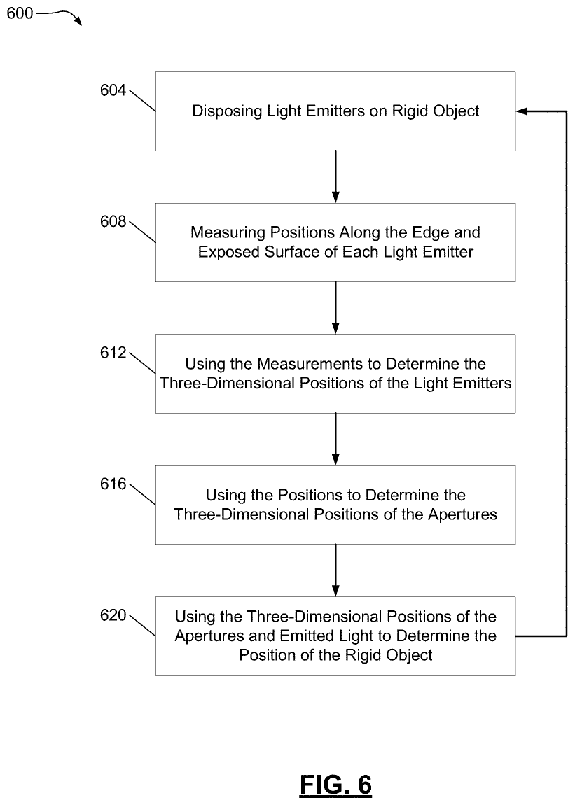

FIG. 6 is a flowchart illustrating an example method 600 for measuring a position of a rigid object to a known reference frame. The method includes, at 604, disposing one or more light emitters (for example, as formed using the process outlined in FIG. 2) onto one or more surfaces of the rigid object. For example, as illustrated in FIGS. 3A-3B, the rigid body may include a plurality of semi-spheres. In such instances, the one or more light emitters may be disposed on the semi-spheres. In all instances, however, as further detailed above, the light emitters are disposed in such a fashion so that the edge of the transparent plate is exposed. One or more positions along the edge and surface of the transparent plate are measured at 608. In various instances, the one or more positions may be measured using a mechanical coordinate-measuring machine—such as a ruby-tipped probe or a sapphire-tipped probe. In certain instances, two or more positions, and optionally three or more positions, are measured along the edge of the transparent plate and two or more positions, and optionally three or more positions, are measured along the exposed surface of the transparent plate, such that at least six total positions on the transparent plate are measured.

At 612, the various edge measurements are used to determine a three-dimensional position of each light emitter, and at 616, the three-dimensional position of the light emitters are used to determine the three-dimensional position of each aperture. For example, using known variables from the precise fabrication of the light emitters—in particular, in cutting the transparent plate and formation of the aperture—the position of each aperture can be inferred when the three-dimensional position of the light emitter is known.

The three-dimensional position of each aperture, together with light received from the various light emitters, are used to determine the position of the rigid object at 620. For example, using known variables from the precise placement of the light emitters on the rigid body, the position of the rigid object can be determined.

Example embodiments are provided so that this disclosure will be thorough, and will fully convey the scope to those who are skilled in the art. Numerous specific details are set forth, such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers, and/or sections, these elements, components, regions, layers, and/or sections should not be limited by these terms. These terms may be used only to distinguish one element, component, region, layer or section from another region, layer or section. Terms such as “first,” “second,” and other numerical terms, when used herein, do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation, in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A system for measuring a position of a rigid object, the system comprising:
one or more light emitters disposed on one or more surfaces of the rigid object, wherein each light emitter comprises:
a light-emitting device having a light-emitting surface,
a transparent plate disposed on the light-emitting surface, and
an opaque film disposed between the light-emitting surface and the transparent plate, wherein the opaque film includes an aperture that is aligned with the light-emitting surface; and
an optical measurement instrument configured to receive light from the one or more light emitters and further configured to determine the position of the rigid object using the received light.

2. The system of claim 1, wherein the transparent plate defines an edge of the light emitter and one or more positions along the edge of the light emitter are measured using a mechanical coordinate-measuring machine (“CMM”).

3. The system of claim 2, wherein the optical measurement instrument is further configured to receive the one or more edge measurements and to use the one or more edge measurements to determine the position of the rigid object.

4. The system of claim 1, wherein the aperture has a first longest dimension that is smaller than a second longest dimension of the light-emitting surface, such that edges of the light-emitting surface are not visible through the aperture over a large angle.

5. The system of claim 1, wherein the aperture has one of a circular shape, an elliptical shape, and a shape of an even-sided polygon, and
wherein the light-emitting surface has one of a circular shape, an elliptical shape, and a shape of an even-sided polygon.

6. The system of claim 1, wherein a first longest dimension of the aperture is greater than 100:1 by ratio of a thickness of the opaque film, and
wherein a first thickness of the transparent plate is greater than a second thickness of the opaque film.

7. The system of claim 1, wherein the transparent plate is a glass plate comprising fused silica, sapphire, soda lime glass, boro-silicate, or a combination thereof, and
wherein the opaque film is a film comprising chrome, silver, aluminum, carbon, dielectric, or a combination thereof.

8. The system of claim 1, wherein the opaque film is disposed on a first surface of the transparent plate using a vapor deposition process and the aperture is formed in the opaque film using an etching process, and
wherein the transparent plate is fabricated using a semiconductor fabrication technique selected from laser dicing and saw dicing.

9. A system of measuring a position of a rigid object, the system comprising:
one or more light emitters disposed on one or more surfaces of the rigid object, wherein each light emitter comprises:
a light-emitting device having a light-emitting surface,
a transparent plate disposed on the light-emitting surface, wherein an opaque film having an aperture defined therein coats a first surface of the transparent plate, and wherein the transparent plate defines an edge of the light emitter; and
an optical measurement instrument configured to receive light from the one or more light emitters and one or more edge measurements for each light emitter, wherein the optical measurement instrument is further configured to determine the position of the rigid object using the received light and the one or more edge measurements.

10. The system of claim 9, wherein the one or more edge measurements are measured using a mechanical coordinate-measuring machine (“CMM”).

11. The system of claim 9, wherein the aperture is registered to the edge of the light emitter and has a first longest dimension that is smaller than a second diameter of the light-emitting surface, such that edges of the light-emitting surface are not visible through the aperture over a large angle, and
wherein the first longest dimension of the aperture is greater than 100:1 by ratio of a thickness of the opaque film and a first thickness of the transparent plate is greater than a second thickness of the opaque film.

12. The system of claim 9, wherein the transparent plate is a glass plate comprising fused silica, sapphire, soda lime glass, boro-silicate, or a combination thereof, and the opaque film is a film comprising chrome, silver, aluminum, carbon, dielectric, or a combination thereof.

13. The system of claim 9, wherein the opaque film covers less than an entire surface area of the first surface of the transparent plate, and exposed areas of the first surface of the transparent plate are bonded to the rigid object.

14. A method for measuring a position of a rigid object, wherein the rigid object includes one or more light emitters disposed on one or more surfaces thereof, the method comprising:
measuring one or more positions along an edge of each light emitter, wherein each light emitter comprises:
a light-emitting device having a light-emitting surface, and
a transparent plate disposed on the light-emitting surface, wherein the transparent plate defines the edge of the light emitter, and an opaque film having an aperture defined therein coats a first surface of the transparent plate;
using the edge measurements, determining a three-dimensional position for each aperture;
receiving light from the one or more light emitters; and
using the light received from the one or more light emitters and the three-dimensional position of each aperture, determining the position of the rigid object.

15. The method of claim 14, wherein the one or more positions along the edge of the light emitter are measured using a mechanical coordinate-measuring machine (“CMM”).

16. The method of claim 14, wherein the opaque film is disposed on the first surface of the transparent plate using a vapor deposition process and the aperture is formed in the opaque film using an etching process, and
wherein the transparent plate is fabricated using a semiconductor fabrication technique selected from laser dicing and saw dicing.

17. The method of claim 14, wherein the aperture has a first longest dimension that is smaller than a second dimension of the light-emitting surface, such that edges of the light-emitting surface are not visible through the aperture over a large angle, and
wherein the first longest dimension of the aperture is greater than 100:1 by ratio of a thickness of the opaque film and a first thickness of the transparent plate is greater than a second thickness of the opaque film.

18. The method of claim 14, wherein the transparent plate is a glass plate comprising fused silica, sapphire, soda lime glass, boro-silicate, or a combination there, and the opaque film is a film comprising chrome, silver, aluminum, carbon, dielectric, or a combination thereof.
